(19) United States
(12) Patent Application Publication
(10) Pub. No.: US 2008/0018552 A1
(43) Pub. Date: Jan. 24, 2008

(54) Electronic apparatus

(76) Inventors: Yuji Nakajima, Nishitama-gun (JP); Masato Nakatani, Kawaguchi-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/804,655

(22) Filed: May 18, 2007

(30) Foreign Application Priority Data
Jul. 20, 2006 (JP) 2006-197761

(51) Int. Cl. H01Q 3/02; H01Q 1/22

(52) U.S. Cl. 343/882

(57) ABSTRACT

According to one embodiment, an electronic apparatus includes a housing including a top wall portion and a side wall portion, a functional part provided on the side wall portion, and an antenna supported by the side wall portion and swingable between a first position where the antenna is opposed to the side wall portion and a second position where the antenna stands with respect to the top wall portion. The antenna includes a support portion swingably supported by the side wall portion, a first portion which extends from the support portion toward an edge portion of the side wall portion when the antenna is in the first position, and a second portion which extends from an end portion of the first portion along an area between the functional portion and the edge portion of the side wall portion when the antenna is in the first position.

### CROSS-REFERENCE TO RELATED APPLICATIONS

This application is based upon and claims the benefit of priority from Japanese Patent Application No. 2006-197761, filed Jul. 20, 2006, the entire contents of which are incorporated herein by reference.

### BACKGROUND

1. Field

One embodiment of the invention relates to an electronic apparatus, for example, having an antenna swingably supported by a housing.

2. Description of the Related Art

Some electronic apparatuses, such as portable computers, have an antenna for wireless LAN or portable terminal. Such an antenna is generally contained in a display unit of an electronic apparatus.

Jpn. Pat. Appln. KOKAI Pub. No. 2001-67139 discloses an information processing apparatus having an antenna provided outside a housing. The information processing apparatus has an antenna device which is detachably attached to a side surface of a main body. An antenna portion of the antenna device is laid down along a side surface of the main body when not used, and is stood almost vertical to a direction along the side surface of the main body when used.

Further, an electronic apparatus has been proposed, in which an antenna is mounted in a hinge portion supporting a display unit. The antenna is swingably supported by the hinge portion, and is swingable between a position where the antenna is laid along the side surface of the main body, and a position where the antenna stands upward.

In recent years, further downsizing of electronic apparatuses is required. To achieve downsizing of electronic apparatuses, it is effective to provide an antenna outside the display unit to save the mounting space inside the display unit.

The antenna device of the above information processing apparatus is attached to a side wall portion of the housing. In the case such an antenna device is attached to the side wall portion of the housing, a mounting area for connectors and slots to be provided in the side wall portion is limited. Therefore, the information processing apparatus is not suitable for downsizing.

Further, in the above electronic apparatus in which the antenna is mounted in the hinge portion, a structure around the hinge portion is complicated. This is not preferable for achieving downsizing of electronic apparatuses.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment of the invention;

FIG. 2 is an exemplary perspective view of an antenna according to the first embodiment;

FIG. 3 is an exemplary cross-sectional view of the antenna of FIG. 2, taken along line F3-F3 of FIG. 2;

FIG. 4 is an exemplary right side view of the antenna of the first embodiment, illustrating a state where the antenna is folded;

FIG. 5 is an exemplary plan view of the antenna of the first embodiment, illustrating a state where the antenna is folded;

FIG. 6 is an exemplary cross-sectional view of the antenna of FIG. 5, taken along line F6-F6;

FIG. 7 is an exemplary right side view of the antenna of the first embodiment, illustrating a state where the antenna is stood;

FIG. 8 is an exemplary plan view of the antenna of the first embodiment, illustrating a state where the antenna is stood;

FIG. 9 is an exemplary cross-sectional view of the antenna of FIG. 8, taken along line F9-F9;

FIG. 10 is an exemplary left side view of the antenna according to the first embodiment, illustrating a folded state and a standing state of the antenna;

FIG. 11 is an exemplary perspective view of a display unit according to the first embodiment, illustrating a state where the display unit is folded;

FIG. 12 is an exemplary perspective view of the antenna of the first embodiment when the display unit is folded;

FIG. 13 is an exemplary schematic diagram of the portable computer of the first embodiment;

FIG. 14 is an exemplary perspective view of a portable computer according to a second embodiment of the invention, illustrating a cross section of a part of the portable computer; and

FIG. 15 is an exemplary cross-sectional view of the portable computer according to the second embodiment.

### DETAILED DESCRIPTION

Various embodiments according to the invention will be described hereinafter with reference to the accompanying drawings. In general, according to one embodiment of the invention, an electronic apparatus includes a housing including a top wall portion and a side wall portion, a functional part provided on the side wall portion, and an antenna supported by the side wall portion and swingable between a first position where the antenna is opposed to the side wall portion and a second position where the antenna stands with respect to the top wall portion. The antenna includes a support portion swingably supported by the side wall portion, a first portion which extends from the support portion toward an edge portion of the side wall portion when the antenna is in the first position, and a second portion which extends from an end portion of the first portion along an area between the functional portion and the edge portion of the side wall portion when the antenna is in the first position.

Embodiments of the present invention are explained with reference to the drawings, in which the present invention is applied to a portable computer.

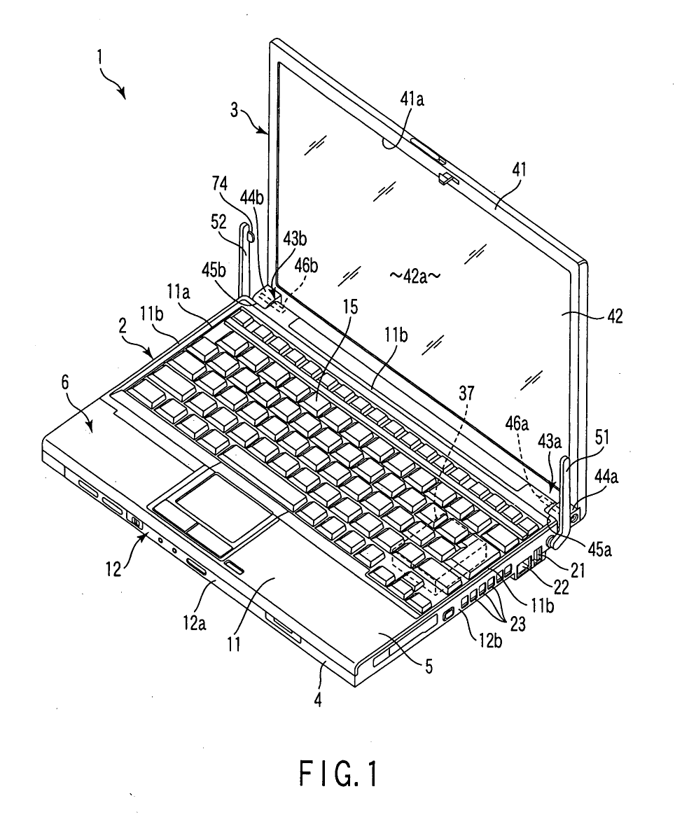

FIGS. 1 to 13 illustrate a portable computer 1 serving as an electronic apparatus according to a first embodiment of the present invention. As shown in FIG. 1, the portable computer 1 includes a main body 2 and a display unit 3.

The main body 2 has a housing base 4 and a housing cover 5. The housing cover 5 is combined with the housing base 4 from above. With the housing base 4 joined with the housing cover 5, the main body 2 has a housing 6 having a box shape. The housing 6 has a top wall portion 11, a peripheral wall portion 12, and a bottom wall portion 13 (see FIG. 3). The peripheral wall portion 12 has a front wall portion 12a extending from a front edge of the top wall portion 11, a right side wall portion 12b extending from a right edge of the top wall portion 11, a left side wall portion 12c extending from a left edge of the top wall portion 11, and a rear wall portion (not shown) extending from a rear edge of the top wall portion 11.

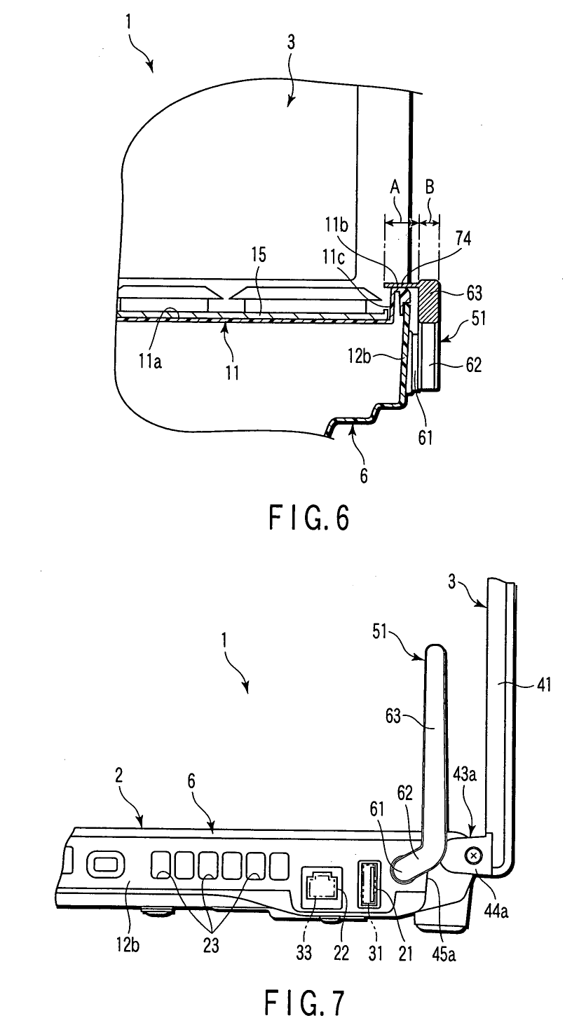

The top wall portion 11 of the housing 6 has a keyboard placing portion 11a, and a frame portion 11b formed around the keyboard placing portion 11a. The frame portion 11b forms an upper surface of the top wall portion 11. As shown in FIG. 6, the keyboard placing portion 11a is formed to be lower than the frame portion 11b by one step inside the housing 6.

A standing wall 11c stands upward from a peripheral edge of the keyboard placing portion 11a. The standing wall 11c connects an edge portion of the keyboard placing portion 11a to an edge portion of the frame portion 11b. Although FIG. 6 only shows the right end portion of the housing 6, the same is applicable to the left end portion of the housing 6. A keyboard 15 is placed on the keyboard placing portion 11a. The keyboard 15 is supported by the keyboard placing portion 11a from below.

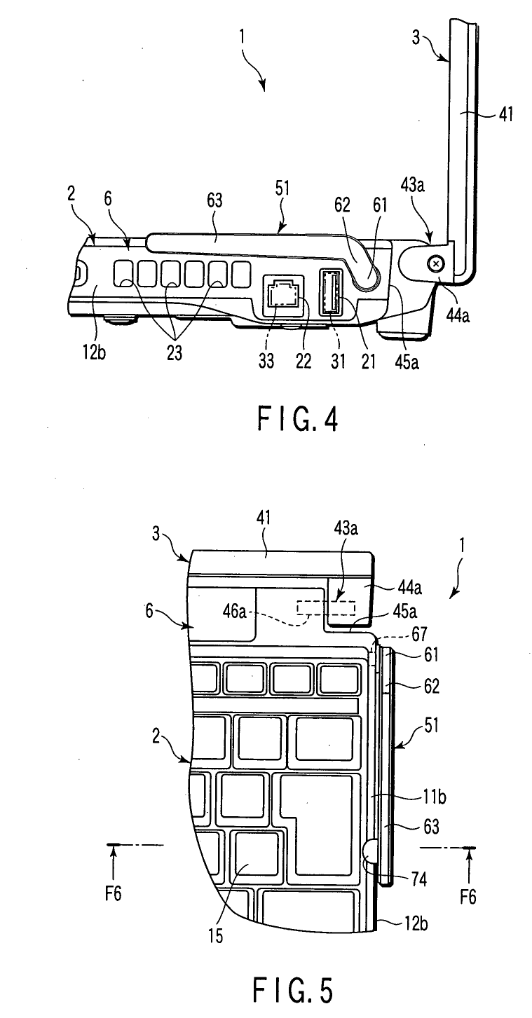

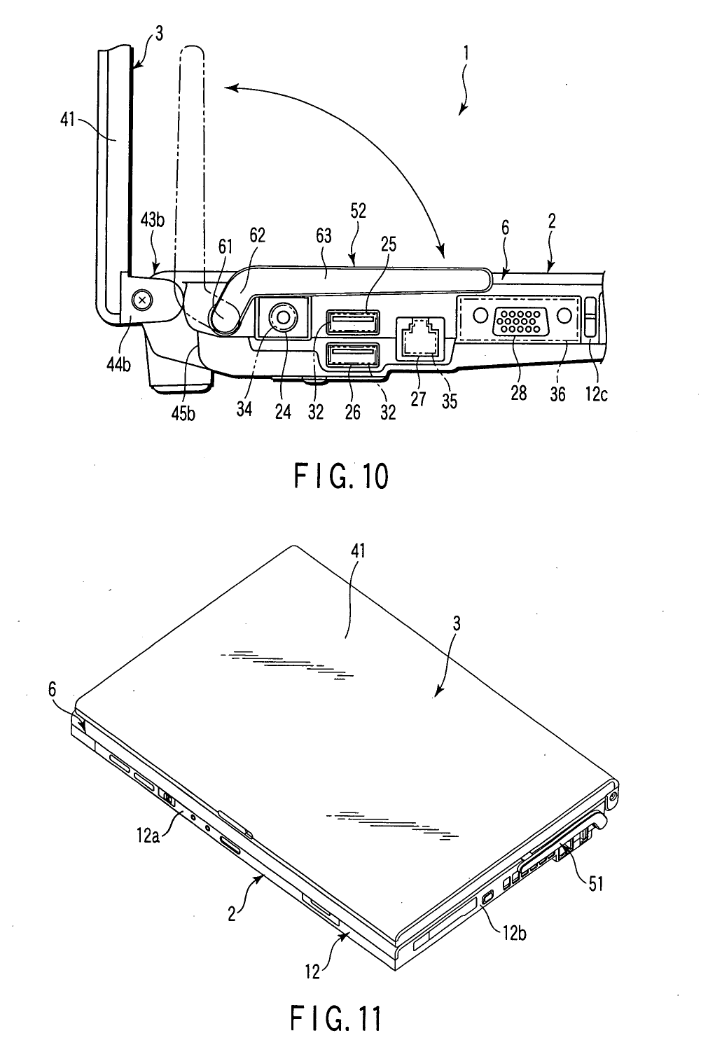

As shown in FIG. 4, a USB connector 21, a modem connector 22, and air vents 23 are provided on the right side wall portion 12b in this order from the rear end side of the right side wall portion 12b. On the other hand, as shown in FIG. 10, a power supply connector 24, USB connectors 25 and 26, a LAN connector 27, and an RGB connector 28 are provided on the left side wall portion 12c of the housing 6 in this order from the rear end side of the left side wall portion 12c.

The USB connectors 21, 25 and 26, the modem connector 22, the power supply connector 24, the LAN connector 27, and the RGB connector 28 are examples of connecting portions to and from which external components are connected and disconnected, and examples of functional parts of the present invention. The air vents 23 are an example of the functional parts. The types of the functional parts are not limited to them. Various parts or structures can be adopted as the functional parts, such as a PC card slot, an SD card slot, a disk drive, a remote control light-receiving portion, various input and output terminals, a volume control, and a switch.

As shown in FIGS. 4 and 10, for example, a USB memory 31 and a USB cable 32 are inserted in and removed from the USB connectors 21, 25 and 26. A modem cable 33 is inserted in and removed from the modem connector 22. A power-supply cable 34 is inserted in and removed from the power supply connector 24. A LAN cable 35 is inserted in and removed from the LAN connector 27. An RGB cable 36 is inserted in and removed from the RGB connector 28. The USB memory 31, the USB cable 32, the modem cable 33, the power supply cable 34, the LAN cable 35, and the RGB cable 36 are examples of the external components.

As shown in FIG. 1, the housing 6 has a cooling fan 37 inside. The cooling fan 37 takes in the air in the housing 6, and discharges this air toward the air vents 23. The air discharged from the cooling fan 37 is discharged to the outside of the housing 6 through the air vents 23.

The display unit 3 has a display housing 41, and a liquid crystal display panel 42 contained in the display housing 41. The liquid crystal display panel 42 has a display screen 42a. The display screen 42a is exposed to the outside of the display housing 41, through an opening portion 41a in a front surface of the display housing 41.

The display unit 3 is supported by a rear end portion of the housing 6 via a pair of hinge portions 43a and 43b. Therefore, the display unit 3 is swingable between a closed position (refer to FIG. 11), in which the display unit 3 is laid down to cover the top wall portion 11, and an open position (refer to FIG. 1), in which the display unit 3 stands to expose the top wall portion 11.

The hinge portions 43a and 43b are next explained in detail. An example of the hinge portions 43a and 43b is L-shaped hinges. Specifically, a pair of leg portions 44a and 44b are provided on a lower end portion of the display housing 41. The leg portions 44a and 44b are provided on right and left ends of the display unit 3, respectively, apart from each other in the width direction. Further, each of the leg portions 44a and 44b projects from the front surface of the display housing 41, along the thickness direction of the display unit 3.

The housing 6 of the main body 2 has a pair of concave portions 45a and 45b. One concave portion 45a is formed in the right rear end portion of the housing 6. The other concave portion 45b is formed in the left rear end portion of the housing 6. The leg portions 44a and 44b of the display unit 3 are arranged in respective areas opened by the concave portions 45a and 45b, respectively. For example, the hinge portion 43a has a hinge device 46a including a pivot. The hinge device 46a is provided to connect the leg portion 44a with the housing 6, and swingably joins the display unit 3 to the housing 6. In the same manner, the hinge portion 43b has a hinge device 46b including a pivot. The hinge device 46b is provided to connect the leg portion 44b with the housing 6, and swingably joins the display unit 3 to the housing 6.

As shown in FIG. 1, left and right antennas 51 and 52 forming a pair are provided on the peripheral wall portion 12 of the housing 6. Specifically, the right antenna 51 is swingably supported by the right side wall portion 12b of the housing 6. The left antenna 5 is swingably supported by the left side wall portion 12c of the housing 6. The antennas 51 and 52 exert a diversity function in cooperation with each other.

It is not always necessary to provide both of the antennas 51 and 52. Only one of the antennas may be provided. Examples of the antennas 51 and 52 are 3G antennas, wireless LAN antennas, and Bluetooth antennas. However, the type of the antennas 51 and 52 is not limited to them.

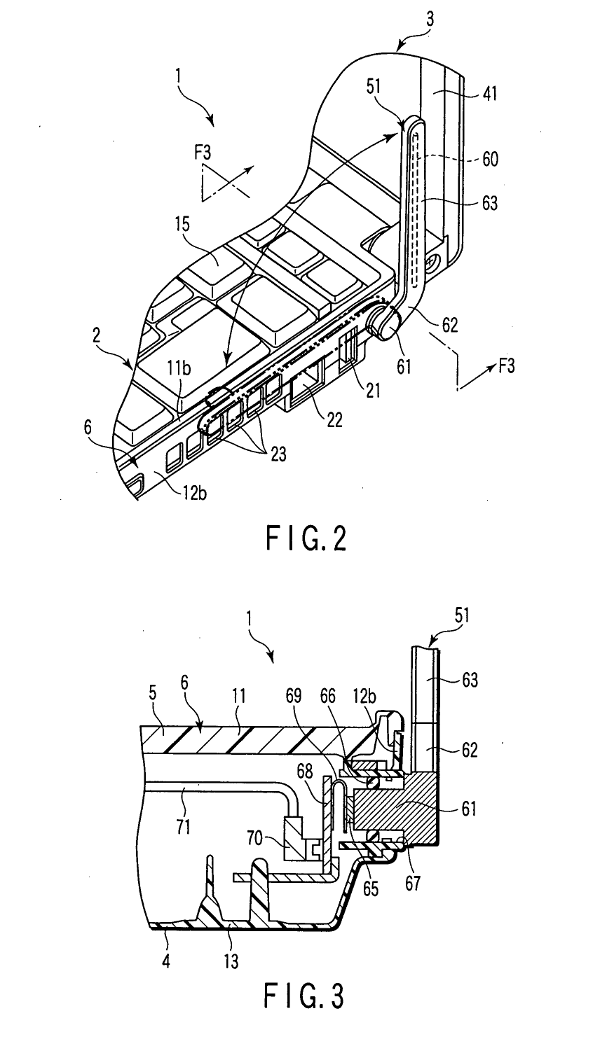

The right antenna 51 is explained next in detail with reference to FIGS. 2 to 9. The left antenna 52 and the right antenna 51 are symmetrical, and the left antenna 52 has the same function as that of the right antenna 51. Therefore, the same reference numerals are assigned to constituent elements having the same function, and detailed explanations thereof are omitted.

As shown in FIG. 2, the right antenna 51 (hereinafter simply referred to as “antenna 51”) is swingable between a first position where the antenna 51 is opposed to the right side wall portion 12b of the housing 6, and a second position where the antenna 51 stands with respect to the top wall portion 11 and extends away from the right side wall portion 12b. The term “antenna” in the present specification indicates an antenna device including a receiver and an exterior member containing the receiver. The antenna 51 has, for example, a line-shaped receiver 60 inside.

The antenna 51 has a support portion 61, a first portion 62, and a second portion 63. The second portion 63 is an example of an antenna main body portion of the present invention. As shown in FIG. 3, the support portion 61 is provided in one end portion of the antenna 51, and projects toward the inside of the housing 6. The support portion 61 has a stepped column shape, and has a metallic connecting terminal 65 on the distal end thereof. The support portion 61 of the antenna 51 is inserted into an elastic ring 66. An example of the elastic ring 66 is a rubber member.

A mounting hole 67 through which the antenna 51 is mounted is formed in the right side wall portion 12b of the housing 6. As shown in FIG. 5, the mounting hole 67 is provided in an area adjacent to the concave portion 45a in the right side wall portion 12b. As shown in FIG. 3, the support portion 61 of the antenna 51 is inserted into the mounting hole 67. The support portion 61 of the antenna 51 inserted into the mounting hole 67 is rotatable with respect to the mounting hole 67. The elastic ring 66 is interposed between the internal circumferential surface of the mounting hole 67 and the support portion 61 of the antenna 51. The support portion 61 of the antenna 51 is prevented from falling out of the mounting hole 67 by frictional resistance of the elastic ring 66.

A circuit board 68 is provided inside the housing 6, and opposed to the connecting terminal 65 of the antenna 51. A metallic leaf spring 69 is soldered to the circuit board 68. The leaf spring 69 is interposed between the circuit board 68 and the connecting terminal 65 of the antenna 51, and electrically connects them to each other. A connector 70 is mounted on the circuit board 68. The circuit board 68 is electrically connected to a main circuit board (not shown) through a coaxial cable 71 connected to the connector 70.

FIGS. 4 to 6 illustrate the antenna 51 in the first position. The support portion 61 of the antenna 51 is positioned at the side of the keyboard 15. The first portion 62 of the antenna 51 extends from the support portion 61 toward the upper edge portion of the right side wall portion 12b. In other words, the first portion 62 extends from the support portion 61 along a direction crossing a direction facing the USB connector 21 and the modem connector 22. The distal end of the first portion 62 is opposed to the upper edge portion of the right side wall portion 12b. The second portion 63 extends from the distal end of the first portion 62 toward the front of the main body 2.

The second portion 63 extends along a direction crossing an extending direction of the first portion 62. The second portion 63 extends along the upper edge portion of the right side wall portion 12b. In other words, the second portion 63 extends along an area between the upper edge of the right side wall portion 12b and the USB connector 21, the modem connector 22, or the air vents 23.

In other words, the second portion 63 is shifted toward the upper edge portion of the right side wall portion 12b from the support portion 61. Specifically, the second portion 63 extends apart from a horizontal line running through the center of the support portion 61. In other words, it can be said that the antenna 51 is bent not to overlap the USB connector 21, the modem connector 22 and the air vents 23.

As shown in FIG. 5, an overhanging portion 74 is provided on the distal end portion of the second portion 63. The overhanging portion 74 projects from the housing-side side surface of the second portion 63. The overhanging portion 74 is opposed to the top wall portion 11 of the housing 6. When the antenna 51 is in the first position, the overhanging portion 74 comes into contact with the frame portion 11b of the top wall portion 11, as shown in FIG. 6. In other words, since the overhanging portion 74 comes into contact with the top wall portion 11, the antenna 51 is rested in the first position.

As shown in FIG. 6, the overhanging portion 74 projects to be larger than the thickness of the second portion 63. An example of the length A of the overhanging portion 74 is 5.0 mm, and an example of the thickness B of the second portion 63 is 3.0 mm. The overhanging portion 74 projects from a part serving as the upper end portion in the second portion 63 when the antenna 51 is in the first position.

FIGS. 7 to 9 illustrate the antenna 51 in the second position. The first portion 62 of the antenna 51 extends from the support portion 61 toward the display unit 3. In other words, the first portion 62 extends from the support portion 61 toward an area diverted from the side of the keyboard 15. The distal end of the first portion 62 reaches an area diverted from the side of the keyboard 15. The second portion 63 extends from the distal end of the first portion 62 toward the upward space of the main body 2.

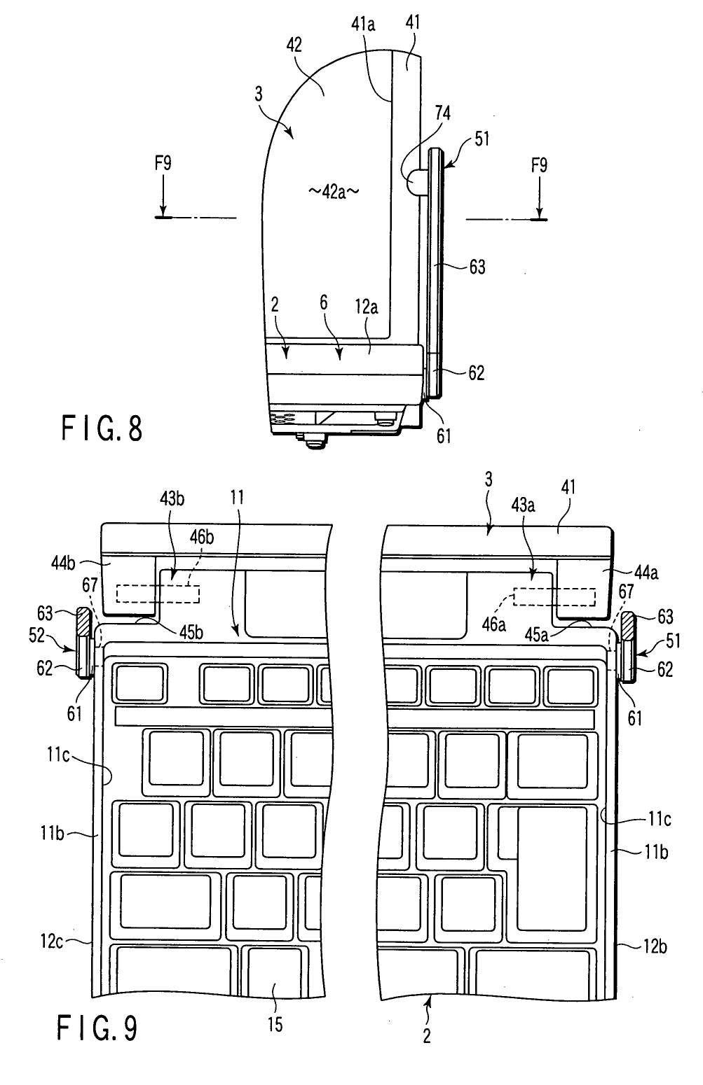

The second portion 63 extends along a direction standing from the top wall portion 11 of the housing 6. As shown in FIG. 9, the second portion 63 stands away from the side of the keyboard 15. In other words, the second portion 63 is shifted toward the display unit 3 from the support portion 61. Specifically, the second portion 63 extends apart from a vertical line running through the center of the support portion 61. In other words, it can be said that the antenna 51 is bent such that a part of the antenna 51 higher than the keyboard 15 is diverted from the side of the keyboard 15. As shown in FIG. 8, when the antenna 51 is in the second position, the overhanging portion 74 of the antenna 51 is opposed to the right edge portion of the display unit 3.

Next, the left antenna 52 is explained with reference to FIG. 10. The left antenna 52 is also swingable between a first position where the left antenna 52 is opposed to the left side wall portion 12c of the housing 6, and a second position where the left antenna 52 stands with respect to the top wall portion 11. The left antenna has a support portion 61, a first portion 62, and a second portion 63.

When the left antenna 52 is in the first position, the first portion 62 of the left antenna 52 extends from the support portion 61 toward the upper edge portion of the left side wall portion 12c. The second portion 63 of the left antenna 52 extends along an area between the upper edge of the left side wall portion 12c and the power supply connector 24, the USB connectors 25 and 26, or the LAN connector 27. FIG. 9 illustrates the left antenna 52 in the second position. When the left antenna 52 is in the second position, the second portion 63 stands away from the side of the keyboard 15.

The exterior members of the antennas 51 and 52 are formed of, for example, elastic members. An example of the exterior members of the antennas 51 and 52 is rubber members. If the antennas 51 and 52 have elasticity, the antennas 51 and 52 are elastically deformed when the user accidentally touches the antennas 51 and 52. Specifically, the external force by the user is not directly applied to the support portion 61, and breakage of the support portion 61 and its periphery is prevented.

Next, operation of the portable computer 1 is explained.

When the portable computer 1 is used, the display unit 3 is raised and stood to the open position with respect to the housing 6. Thereby, the keyboard 15 and the display screen 42a are exposed to the outside. The user can input information to the portable computer 1 by operating the keyboard 15.

The right and left antennas 51 and 52 are folded down to the first position when not used. Further, under the circumstances where sufficient reception sensitivity is obtained in the first position, the antennas 51 and 52 may be used in the first position. As shown in FIG. 4, the right antenna 51 in the first position does not cover the USB connector 21, the modem connector 22 and the air vents 23.

Therefore, the user can connect and disconnect the external components 31 and 33 to and from the connectors 21 and 22, without being obstructed by the right antenna 51 even when the right antenna 51 is folded down. In other words, the antenna 51 can be folded down, even in the state where the external components such as the USB memory 31 and the modem cable 33 are connected to the portable computer 1. Further, the function of the air vents 23 is not reduced even in the state where the right antenna 51 is folded, and thus the cooling fan 37 can discharge the inside air to the outside of the housing 6 through the air vents 23.

As shown in FIG. 10, the left antenna 52 in the first position does not cover the power supply connector 24, the USB connectors 25 and 26, the LAN connector 27 and the RGB connector 28. Therefore, the user can connect and disconnect the external components 32, 34, 35 and 36 to and from the connectors 24, 25, 26, 27 and 28, without being obstructed by the left antenna 52 even in the state where the left antenna 52 is folded down.

The right and left antennas 51 and 52 are raised and stood to the second position when used. When the antennas 51 and 52 are stood, the second portions 63 of the antennas 51 and 52 are decentered from the support portion 61, and shifted to the display unit side. Thereby, as shown in FIG. 9, the second portions of the right and left antennas 51 and 52 in the second position are shifted from the sides of the keyboard 15 toward the rear end portion. Therefore, the user can use the keyboard.15 without being obstructed by the antennas 51 and 52.

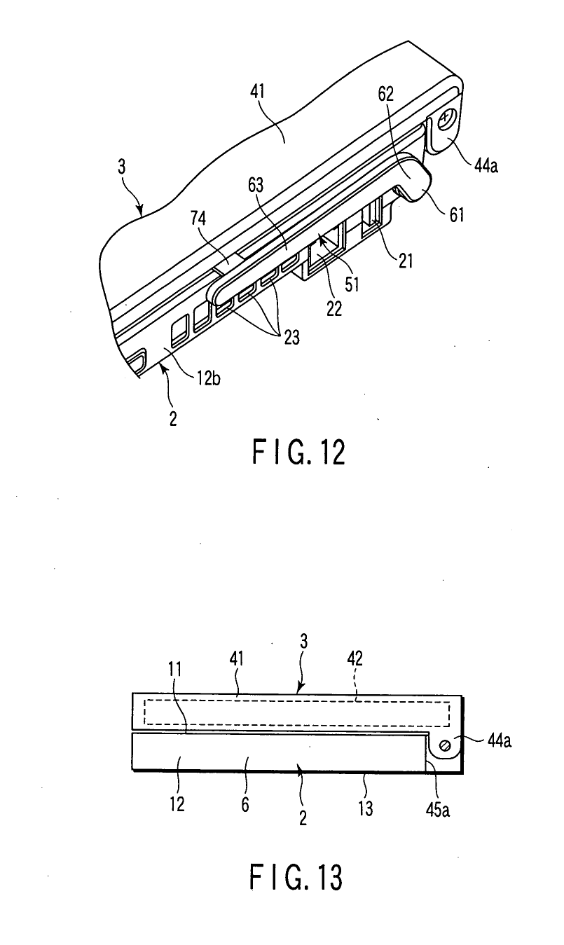

As shown in FIG. 11, when the portable computer 1 is not used, the display unit 3 folded flat to the closed position in which the display unit 3 covers the top wall portion 11 of the housing 6. As shown in FIG. 12, when the display unit 3 is folded, the overhanging portions 74 of the right and left antennas 51 and 52 are held between the housing 6 and the display unit 3, and thereby the right and left antennas 51 and 52 are held.

According to the portable computer 1 having the above structure, downsizing is enabled without much loss of usability. Specifically, the right and left antennas 51 and 52 do not cover the connectors 22 to 28 even in the first position in which they are folded. Therefore, it is possible to use the connectors 22 to 28 with the antennas 51 and 52 folded. Thereby, even when the antennas 51 and 52 are mounted outside the housing 6, the usability of the portable computer 1 is not deteriorated.

In other words, adopting the antennas 51 and 52 having the above structure secures a large area for mounting connectors in the side wall portions 12b and 12c of the housing 6. This contributes to downsizing of the portable computer 1. Further, according to the antennas 51 and 52 of the first embodiment, even if the support portions 61 of the antennas 51 and 52 are mounted in an area horizontally aligned with the USB connector 21 and the power supply connector 24, the antennas 51 and 52 do not cover the connectors 21 to 28. Specifically, it is possible to reduce the thickness of the housing 6. This also contributes to downsizing of the portable computer 1.

For example, the antenna portion disclosed in Jpn. Pat. Appln. KOKAI Pub. No. 2001-67139 stands at the side of the keyboard when it is used, and thus may impair the operability of keys of the keyboard located in the vicinity of the antenna. Further, the antenna may obstruct the movement of the user's hands upon the user's hands leaving the keyboard to pick something up placed at the side of the information processing apparatus, which is inconvenient.

However, according to the portable computer 1 of the first embodiment of present invention, the right and left antennas 51 and 52 are deviated from the side of the keyboard 15, and stand in an area close to the display unit 3. Therefore, the user can operate the keyboard 15 without being obstructed by the right and left antennas 51 and 52. Further, upon the user's hands leaving the keyboard to pick something up placed at the side of the portable computer 1, the user does not have to detour the antennas 51 and 52, and thus can move his or her hands in the shortest route. As described above, the usability of the portable computer 1 hardly deteriorates even with the antennas 51 and 52 mounted outside the housing 6. Further, since the second portions 63 of the antennas 51 and 52 stand in the area close to the display unit 3, the antennas 51 and 52 hardly block the user's view, either.

Next, downsizing of the portable computer 1 is explained.

For example, since the antennas are attachable to the side wall portions 12b and 12c of the housing 6 instead of being mounted inside the display unit 3, mounting space inside the display housing 41 is saved. Therefore, as shown in FIG. 13, the size of the display housing 41 with respect to the size of the liquid crystal display panel 42 is reduced. Therefore, the portable computer 1 is downsized.

Since the portable computer 1 has the L-shaped hinge portions 43a and 43b, the footprint (i.e. the area of the bottom surface) of the housing 6 with respect to the size of the display housing 41 is reduced. This also contributes to downsizing of the portable computer 1.

Further, since the portable computer 1 has the L-shaped hinge portions 43a and 43b, the concave portions 45a and 45b receiving the hinge portions are formed on the rear end portion of the housing 6. Since the concave portions 45a and 45b are formed in the right rear end portion and the left rear end portion of the housing 6, respectively, the right and left antennas 51 and 52 are mounted at the sides of the keyboard 15, or in areas close to the sides of the keyboard 15.

However, as described above, the right and left antennas 51 and 52 of the first embodiment hardly decrease the usability of the portable computer 1, even when they are mounted at the sides of the keyboard 15. Therefore, the portable computer 1 of the first embodiment achieves downsizing without much loss of usability.

The portable computer 1 has the overhanging portions 74, which comes into contact with the top wall portion 11 of the housing 6 when the antennas 51 and 52 are in the first position. The overhanging portions 74 prevent the antennas 51 and 52 from rotating below the first position.

Since the overhanging portions 74 are opposed to the edge portions of the display unit 3 when the antennas 51 and 52 are in the second position, the overhanging portions 74 come into contact with the front surface of the display unit 3 even if the antennas 51 and 52 are further rotated toward the display unit 3. Specifically, the overhanging portions 74 prevent the antennas 51 and 52 from rotating to the rear of the display unit 3.

Specifically, the antennas 51 and 52 are always maintained between the housing 6 and the display unit 3, without providing any special stopper mechanism around the support portions 61. Since the swingable range of the antennas 51 and 52 is limited to the area between the housing 6 and the display unit 3, the antennas 51 and 52 are prevented from interfering with the USB memory 31 and the power supply cable 34 and other devices connected to the connectors 21 to 28, and from falling down to the back side of the portable computer 1.

Since the overhanging portions 74 projects from upper end portions of the second portions 63 when the antennas 51 and 52 are in the first position, the upper ends of the antennas 51 and 52 are almost as high as the upper end of the housing 6. Therefore, the antennas 51 and 52 in the first position hardly hinder the user from operating the keyboard 15.

Since the overhanging portions 74 of the antennas 51 and 52 is held between the housing 6 and the display unit 3 in the closed position, the antennas 51 and 52 are locked between the housing 6 and the display unit 3. Since the antennas 51 and 52 are securely locked along the housing 6, breakage of the antennas 51 and 52 is prevented, even when the portable computer 1 is put in a bag or the like with the antennas 51 and 52 attached.

With the antennas 51 and 52 having elasticity, the overhanging portions 74 may fall out of the housing 6 and the display unit 3 if the overhanging portions 74 are small. Therefore, for example, the overhanging portions 74 are made to be larger than the thickness of the second portions 63. This reduces the possibility that the overhanging portions 74 fall out of the housing 6 and the display unit 3.

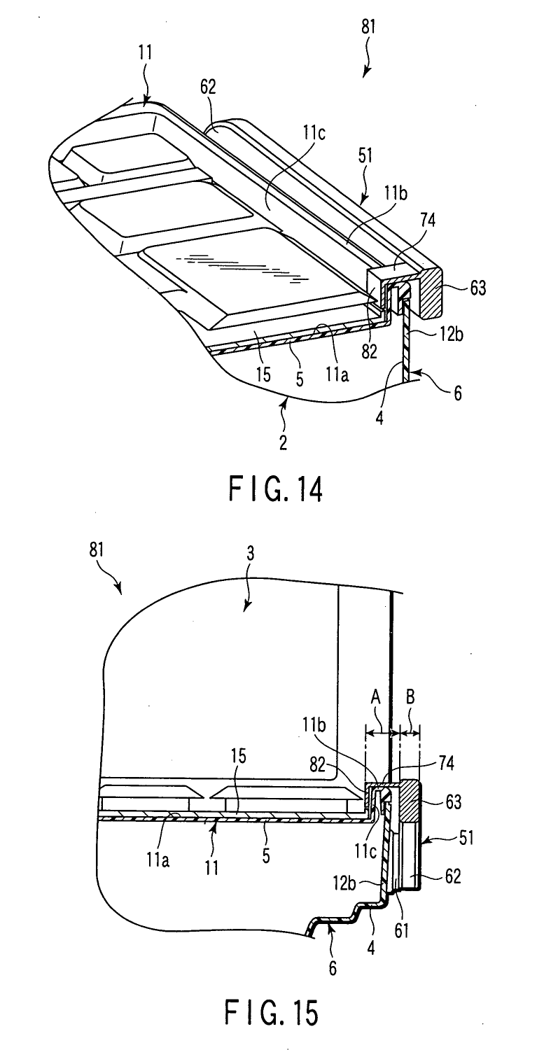

Next, a portable computer 81 serving as an electronic apparatus according to the second embodiment of the present invention is explained with reference to FIGS. 14 and 15. Constituent elements having the same functions as those in the portable computer 1 of the first embodiment are denoted by the same reference numerals, and explanations thereof are omitted.

The portable computer 81 has a main body 2 and a display unit 3. The display unit 3 is supported on the rear end portion of a housing 6 of the main body by hinge portions 43a and 43b. Right and left antennas 51 and 52 forming a pair are swingably supported by the housing 6.

Each of the right and left antennas 51 and 52 has a support portion 61, a first portion 62, and a second portion 63. An overhanging portion 74 is provided to the second portion 63 of each of the right and left antennas 51 and 52. The overhanging portion 74 projects from a side surface of the second portion 63 to the boundary between a keyboard placing portion 11a and a standing wall 11c. As shown in FIGS. 14 and 15, each of the right and left antennas 51 and 52 according to the second embodiments has a hook 82 extending from the distal end of the overhanging portion 74 toward the housing 6. The hook 82 extends along the wall 11c standing from the keyboard placing portion 11a, and is opposed to the wall 11c.

According to the portable computer 81 having the above structure, downsizing of the portable computer is achieved without much loss of usability, for the same reason as that of the portable computer 1 of the first embodiment. Further, according to the portable computer 81 of the second embodiment, breakage of the antennas 51 and 52 is further prevented. Specifically, the antennas 51 and 52 having elasticity may fall out of the housing 6 and the display unit 3 by external force even when the overhanging portions 74 are held between the housing 6 and the display unit 3.

According to the antennas 51 and 52 of the second embodiment, even when the overhanging portions 74 move toward the outside of the housing 6, the hooks 82 are engaged with the wall 11c and thus the antennas 51 and 52 are not easily disconnected from the housing 6. Therefore, it is possible to prevent breakage of the antennas 51 and 52 caused by accidental disconnection of the antennas 51 and 52 from the housing 6.

Embodiments of the present invention are not limited to the portable computers 1 and 81 according to the first and second embodiments described above. For example, the support portions 61 of the antennas 51 and 52 are not always have to be provided at the sides of the keyboard 15. Antennas mounted in an area distant from the sides of the keyboard 15 do not cover the connectors, either, as long as the antennas have the first portion 62 and the second portion 63. Therefore, even when the antennas are mounted to the side wall portions 12b and 12c of the housing 6, the usability of the portable computer is not much deteriorated.

For example, the overhanging portion 74 is not always necessary. Even antennas not having the overhanging portion 74 also contribute to downsizing of the portable computers 1 and 81, without much deteriorating the usability of the portable computers. Further, electronic apparatuses to which the present invention is applicable are not limited to portable computers.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing including a top wall portion and a side wall portion;
a functional part provided on the side wall portion of the housing; and
an antenna supported by the side wall portion of the housing and swingable between a first position where the antenna is opposed to the side wall portion and a second position where the antenna stands with respect to the top wall portion, the antenna including a support portion swingably supported by the side wall portion, a first portion which extends from the support portion toward an edge portion of the side wall portion when the antenna is in the first position, and a second portion which extends from an end portion of the first portion along an area between the functional part and the edge portion of the side wall portion when the antenna is in the first position.

2. An electronic apparatus according to claim 1, further comprising:
an overhanging portion which is provided in the second portion of the antenna, and comes into contact with the top wall portion of the housing when the antenna is in the first position.

3. An electronic apparatus according to claim 2, wherein
the overhanging portion of the antenna projects from a part of the second portion, which serves as an upper end portion of the second portion when the antenna is in the first position.

4. An electronic apparatus according to claim 3, wherein
the overhanging portion of the antenna projects to be larger than thickness of the second portion.

5. An electronic apparatus according to claim 1, further comprising:
a display unit supported by an end portion of the housing; and
a keyboard placed in the top wall portion of the housing,
wherein the first portion of the antenna extends from the support portion toward the display unit, and the second portion stands away from the side of the keyboard, when the antenna is in the second position.

6. An electronic apparatus according to claim 5, further comprising:
an overhanging portion provided in the second portion of the antenna, and opposed to an edge portion of the display unit when the antenna is in the second position.

7. An electronic apparatus according to claim 6, wherein
the top wall portion of the housing includes a placing portion on which the keyboard is placed, and a wall standing from a peripheral edge of the placing portion, and the antenna includes a hook which extends from a distal end of the overhanging portion along the wall when the antenna is in the first position.

8. An electronic apparatus according to claim 6, wherein
the display unit is swingable between a closed position where the display unit is laid down to cover the top wall portion and an open position where the display unit stands to expose the top wall portion, and the overhanging portion of the antenna is held between the housing and the display unit when the display unit is in the closed position.

9. An electronic apparatus comprising:
a housing including a top wall portion and a side wall portion;
a display unit supported by an end portion of the housing;
a keyboard placed in the top wall portion of the housing;
an antenna supported by the side wall portion of the housing and swingable between a first position where the antenna is opposed to the side wall portion and a second position where the antenna stands with respect to the top wall portion, the antenna including a support portion swingably supported by the side wall portion, and a main body portion which is shifted toward the display unit from the support portion when the antenna is in the second position.

10. An electronic apparatus according to claim 9, wherein
the support portion is positioned at a side of the keyboard, and the main body portion is deviated from the side of the keyboard.

11. An electronic apparatus according to claim 10, further comprising:
an overhanging portion provided in the main body portion of the antenna, and opposed to an edge portion of the display unit when the antenna is in the second position.

12. An electronic apparatus according to claim 11, further comprising:
a connecting portion provided in the side wall portion of the housing and in and from which an external component is inserted and removed,
wherein the main body portion of the antenna is shifted toward an edge portion of the side wall portion from the support portion when the antenna is in the first position.

13. An electronic apparatus according to claim 12, wherein
the overhanging portion of the antenna comes into contact with the top wall portion of the housing when the antenna is in the first position.

14. An electronic apparatus according to claim 13, wherein
the overhanging portion projects from a part of the main body portion which serves as an upper end portion of the second portion when the antenna is in the first position.

15. An electronic apparatus according to claim 14, wherein
the overhanging portion of the antenna projects to be larger than thickness of the main body portion.

16. An electronic apparatus according to claim 15, wherein
the top wall portion of the housing includes a placing portion on which the keyboard is placed, and a wall standing from a peripheral edge of the placing portion, and the antenna includes a hook which extends from a distal end of the overhanging portion along the wall when the antenna is in the first position.

17. An electronic apparatus according to claim 16, wherein
the display unit is swingable between a closed position where the display unit is laid down to cover the top wall portion of the housing and an open position where the display unit stands to expose the top wall portion of the housing, and the overhanging portion of the antenna is held between the housing and the display unit when the display unit is in the closed position.
